(19) United States
(12) Patent Application Publication
(10) Pub. No.: US 2011/0143601 A1
(43) Pub. Date: Jun. 16, 2011

(54) CONNECTOR

(75) Inventors: Masayoshi KATSUI, Kawasaki (JP); Kazuya Orui, Kawasaki (JP)

(73) Assignee: FUJITSU LIMITED, Kawasaki-shi (JP)

(21) Appl. No.: 12/965,875

(22) Filed: Dec. 12, 2010

(30) Foreign Application Priority Data
Dec. 15, 2009 (JP) 2009-284378

(51) Int. Cl. H01R 24/00; H01R 13/40

(52) U.S. Cl. 439/660; 439/733.1

(57) ABSTRACT

A connector which is to be mounted on a substrate includes a housing member having an opening portion in which an electrical device is to be inserted, and a contact member provided in the housing member to electrically connect the electrical device with the substrate. The contact member includes a first portion, a second portion facing the first portion with a gap and supported elastically with respect to the first portion, and a third portion supported by the second portion. The third portion comes into contact with a terminal of the electrical device electrically when the second portion is pushed by a pushing member which is to be inserted into the gap between the first portion and the second portion.

### CROSS-REFERENCE TO RELATED APPLICATIONS

This application is based upon and claims the benefit of priority of the prior Japanese Patent Application No. 2009-284378, filed on Dec. 15, 2009, the entire contents of which are incorporated herein by reference.

### FIELD

The embodiments discussed herein are related to a connector for connection of, for example, a flexible flat cable (FFC) or a flexible printed circuit (FPC).

### BACKGROUND

Currently available connectors for connection of, for example, flexible flat cables (FFCs) and flexible printed circuits (FPCs) include several types such as zero insertion force (ZIF), NON-ZIF, straight, right angle, top contact, and bottom contact. A suitable connector is selected from these connectors with regard to the structure of a product, workability, etc.

Demand on reduction in thickness of a product rapidly increases for a notebook computer (personal computer) or a small device such as a cellular phone. The demand on reduction in thickness is also desired for a connector. In particular, a connector of right angle type is becoming popular because such a connector is advantageous to the reduction in thickness. FIGS. 1A to 1C and 2 are cross-sectional views illustrating conventional connectors of right angle type. Representative examples for the conventional connectors of right angle type will be described below with reference to FIGS. 1A to 1C and 2.

FIG. 1A briefly illustrates a connector 103 of NON-ZIF, top contact, right angle type. The connector 103 includes a contact 104 and a housing 105, and is fixed to a substrate 100 with a solder 102. The contact 104 is an integrally formed thin metal plate. The housing 105 is molded with insulative resin, and has a FPC insertion hole 105x. The contact 104 is press-fitted into the housing 105 and hence fixed.

The contact 104 mainly includes a contact portion 104a, a soldered portion 104b, a press-fit portion 104c, and a support and press-fit portion 104d (the portion which serves as a support portion and a press-fit portion). The contact portion 104a becomes electrically continuous to a FPC 101. The soldered portion 104b causes the contact 104 to be fixed to the substrate 100 with the solder 102 and to be electrically connected with the substrate 100. The FPC 101 is electrically connected with the substrate 100 through the contact portion 104a and the soldered portion 104b. The press-fit portion 104c and the support and press-fit portion 104d fix the contact 104 and the housing 105 together.

The support and press-fit portion 104d also receives a reactive force that is generated when the contact portion 104a is displaced and the FPC 101 is fitted to the contact 104. More specifically, when the FPC 101 is inserted into the FPC insertion hole 105x in a direction indicated by arrow A, the contact portion 104a is displaced upward and the FPC 101 is fitted to the contact 104. A reactive force is generated when the contact portion 104a is displaced and the FPC 101 is fitted to the contact 104. Thus, a portion that receives the generated reactive force is required. If the portion that receives the generated reactive force is not provided, the reactive force may be exerted on the soldered portion 104b, and the solder 102 may be separated from the substrate 100. To avoid this, the support and press-fit portion 104d is provided to receive the reactive force, which is generated when the FPC 101 is fitted to the contact 104, by the support and press-fit portion 104d and to prevent the reactive force from being exerted on the soldered portion 104b.

FIG. 1B briefly illustrates a connector 203 of ZIF, top contact, right angle type. The connector 203 includes a contact 204, a housing 205, and an actuator 206, and is fixed to a substrate 100 with a solder 102. The contact 204 is an integrally formed thin metal plate. The housing 205 is molded with insulative resin, and has a FPC insertion hole 205x. The contact 204 is press-fitted into the housing 205 and hence fixed. The actuator 206 is fixed to the housing 205 movably in a direction indicated by arrow B. When the actuator 206 is operated (moved) in the direction indicated by arrow B, the actuator 206 causes a FPC 101 to be fitted to the contact 204. The connector 203 is of front flip type in which the actuator 206 is provided at a position near to the FPC insertion hole 205x.

The contact 204 mainly includes a contact portion 204a, a soldered portion 204b, a press-fit portion 204c, and a support and press-fit portion 204d (the portion which serves as a support portion and a press-fit portion). The contact portion 204a becomes electrically continuous to the FPC 101. The soldered portion 204b causes the contact 204 to be fixed to the substrate 100 with the solder 102 and to be electrically connected with the substrate 100. The FPC 101 is electrically connected with the substrate 100 through the contact portion 204a and the soldered portion 204b. The press-fit portion 204c and the support and press-fit portion 204d fix the contact 204 and the housing 205 together.

The support and press-fit portion 204d also receives a reactive force that is generated when the contact portion 204a is displaced and the FPC 101 is fitted to the contact 204. More specifically, when the FPC 101 is inserted into the FPC insertion hole 205x in a direction indicated by arrow A and then the actuator 206 is rotated in the direction indicated by arrow B around a support point C, the contact portion 204a is displaced upward and the FPC 101 is fitted to the contact 204. A reactive force is generated when the contact portion 204a is displaced and the FPC 101 is fitted to the contact 204. Thus, a portion that receives the generated reactive force is required. If the portion that receives the generated reactive force is not provided, the reactive force may be exerted on the soldered portion 204b, and the solder 102 may be separated from the substrate 100. To avoid this, the support and press-fit portion 204d is provided to receive the reactive force, which is generated when the FPC 101 is fitted to the contact 204, by the support and press-fit portion 204d and to prevent the reactive force from being exerted on the soldered portion 204b.

FIG. 1C briefly illustrates a connector 303 of ZIF, top contact, right angle type. The connector 303 includes a contact 304, a housing 305, and an actuator 306, and is fixed to a substrate 100 with a solder 102. The contact 304 is an integrally formed thin metal plate. The housing 305 is molded with insulative resin, and has a FPC insertion hole 305x. The contact 304 is press-fitted into the housing 305 and hence fixed. The actuator 306 is fixed to the housing 305 rotatably in a direction indicated by arrow C. When the actuator 306 is operated (rotated) in the direction indicated by arrow C, the actuator 306 causes a FPC 101 to be fitted to the contact 304. The connector 303 is of back flip type in which the actuator 306 is provided at a position far from the FPC insertion hole 305x.

The contact 304 mainly includes a contact portion 304a, a soldered portion 304b, a press-fit portion 304c, and a support and press-fit portion 304d (the portion which serves as a support portion and a press-fit portion). The contact portion 304a becomes electrically continuous to the FPC 101. The soldered portion 304b causes the contact 304 to be fixed to the substrate 100 with the solder 102 and to be electrically connected with the substrate 100. The FPC 101 is electrically connected with the substrate 100 through the contact portion 304a and the soldered portion 304b. The press-fit portion 304c and the support and press-fit portion 304d fix the contact 304 and the housing 305 together.

The support and press-fit portion 304d also receives a reactive force that is generated when the contact portion 304a is displaced and the FPC 101 is fitted to the contact 304. More specifically, when the FPC 101 is inserted into the FPC insertion hole 305x in a direction indicated by arrow A and then the actuator 306 is rotated in the direction indicated by arrow C, the contact portion 304a is displaced downward and the FPC 101 is fitted to the contact 304. A reactive force is generated when the contact portion 304a is displaced and the FPC 101 is fitted to the contact 304. Thus, a portion that receives the generated reactive force is required. If the portion that receives the generated reactive force is not provided, the reactive force may be exerted on the soldered portion 304b, and the solder 102 may be separated from the substrate 100. To avoid this, the support and press-fit portion 304d is provided to receive the reactive force, which is generated when the FPC 101 is fitted to the contact 304, by the support and press-fit portion 304d and to prevent the reactive force from being exerted on the soldered portion 304b.

FIG. 2 briefly illustrates a connector 403 of ZIF, bottom contact, right angle type. The connector 403 includes a contact 404, a housing 405, and an actuator 406, and is fixed to a substrate 100 with a solder 102. The contact 404 is an integrally formed thin metal plate. The housing 405 is molded with insulative resin, and has a FPC insertion hole 405x. The contact 404 is press-fitted into the housing 405 and hence fixed. The actuator 406 is movable in a direction indicated by arrow D. When the actuator 406 is operated (moved) in the direction indicated by arrow D, the actuator 406 causes a FPC 101 to be fitted to the contact 404.

The contact 404 mainly includes a contact portion 404a, a soldered portion 404b, a press-fit portion 404c, a support portion 404d, and a pressure portion 404e. The contact portion 404a becomes electrically continuous to the FPC 101. The soldered portion 404b causes the contact 404 to be fixed to the substrate 100 with the solder 102 and to be electrically connected with the substrate 100. The FPC 101 is electrically connected with the substrate 100 through the contact portion 404a and the soldered portion 404b. The press-fit portion 404c fixes the contact 404 and the housing 405 together. When the actuator 406 is inserted into an area between the pressure portion 404e and the housing 405, the actuator 406 presses the pressure portion 404e. As the result, the pressure portion 404e is displaced in a direction indicated by arrow E.

The support portion 404d receives a reactive force that is generated when the contact portion 404a is displaced and the FPC 101 is fitted to the contact 404. More specifically, when the FPC 101 is inserted into the FPC insertion hole 405x in a direction indicated by arrow A and then the actuator 406 is moved in the direction indicated by arrow D, the pressure portion 404e is displaced in the direction indicated by arrow E, the contact portion 404a is displaced upward, and the FPC 101 is fitted to the contact 404. A reactive force is generated when the contact portion 404a is displaced and the FPC 101 is fitted to the contact 404. Thus, a portion that receives the generated reactive force is required. If the portion that receives the generated reactive force is not provided, the reactive force may be exerted on the soldered portion 404b, and the solder 102 may be separated from the substrate 100. To avoid this, the support portion 404d is provided to receive the reactive force, which is generated when the FPC 101 is fitted to the contact 404, by the support portion 404d and to prevent the reactive force from being exerted on the soldered portion 404b.

It is to be noted that the connector 403 illustrated in FIG. 2 has a special structure. The support point of an actuator typically works on a contact.

The above-described techniques of related art are disclosed in Japanese Laid-open Utility Model Registration Publication No. 7-18386.

The right angle connectors of NON-ZIF (FIG. 1A), ZIF (FIGS. 1B, 1C, 2) have been described above with reference to FIGS. 1A to 1C and 2. The connector of NON-ZIF type is advantageous to the reduction in thickness because the connector does not include an actuator. However, since a pressure is applied to the FPC from ends of the contact when the FPC is inserted, it is difficult to insert the FPC (workability is degraded). In contrast, the connector of ZIF type has no difficulty in the insertion of the FPC (no degradation in workability). Thus, the demand on the reduction in thickness is being increased for the connector of ZIF type.

Also, as described above with reference to FIGS. 1A to 1C and 2, the conventional right angle connector has the structure that obtains a contact pressure between the FPC and the contact as a result of that the support portion receives the reactive force generated when the FPC is fitted to the contact.

Regarding the conventional right angle connector illustrated in FIGS. 1A to 1C and 2, the longitudinal direction of the support portion is substantially parallel to the longitudinal direction of the FPC inserted into the FPC insertion hole, and part of the support portion overlaps part of the FPC inserted into the FPC insertion hole in plan view. Therefore, the thickness of the connector is increased by the thickness of the support portion. That is, the structure of the support portion disturbs the reduction in thickness of the connector.

### SUMMARY

According to an aspect of an embodiment, a connector which is to be mounted on a substrate includes a housing member having an opening portion in which an electrical device is to be inserted, and a contact member provided in the housing member to electrically connect the electrical device with the substrate. The contact member includes a first portion, a second portion facing the first portion with a gap and supported elastically with respect to the first portion, and a third portion supported by the second portion. The third portion comes into contact with a terminal of the electrical device electrically when the second portion is pushed by a pushing member which is to be inserted into the gap between the first portion and the second portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C are cross-sectional views illustrating conventional connectors of right angle type.

FIG. 2 is a cross-sectional view illustrating a conventional connector of right angle type.

FIG. 3 is a perspective view illustrating a connector according to a first embodiment.

FIG. 4 is a front view illustrating the connector according to the first embodiment.

FIG. 5 is a plan view illustrating the connector according to the first embodiment.

FIG. 6 is a right side view illustrating the connector according to the first embodiment.

FIG. 7 is a rear view illustrating the connector according to the first embodiment.

FIG. 8 is a cross-sectional view taken along line VIII-VIII in FIG. 4 illustrating the connector according to the first embodiment.

FIG. 9 is a perspective view illustrating a contact according to the first embodiment.

FIG. 10 is a right side view illustrating the contact according to the first embodiment.

FIG. 11 is a perspective view illustrating an actuator according to the first embodiment.

FIG. 12 is a right side view illustrating the actuator according to the first embodiment.

FIG. 13 is a view for explaining an operation of the actuator according to the first embodiment.

FIG. 14 is a perspective view illustrating an actuator according to a first modification of the first embodiment.

FIG. 15 is a right side view illustrating the actuator according to the first modification of the first embodiment.

FIG. 16 is a view for explaining an operation of the actuator according to the first modification of the first embodiment.

FIG. 17 is a perspective view illustrating an actuator according to a second modification of the first embodiment.

FIG. 18 is a right side view illustrating the actuator according to the second modification of the first embodiment.

FIG. 19 is a view for explaining an operation of the actuator according to the second modification of the first embodiment.

FIG. 20 is a view for explaining an operation of the actuator according to the second modification of the first embodiment.

FIGS. 21A to 21C are views for explaining an operation of the actuator according to a third modification of the first embodiment.

### DESCRIPTION OF EMBODIMENTS

Embodiments will be described below with reference to the attached drawings. In the drawings, the same reference signs are occasionally used for the same components and description for such components is omitted if the components have been described.

### First Embodiment

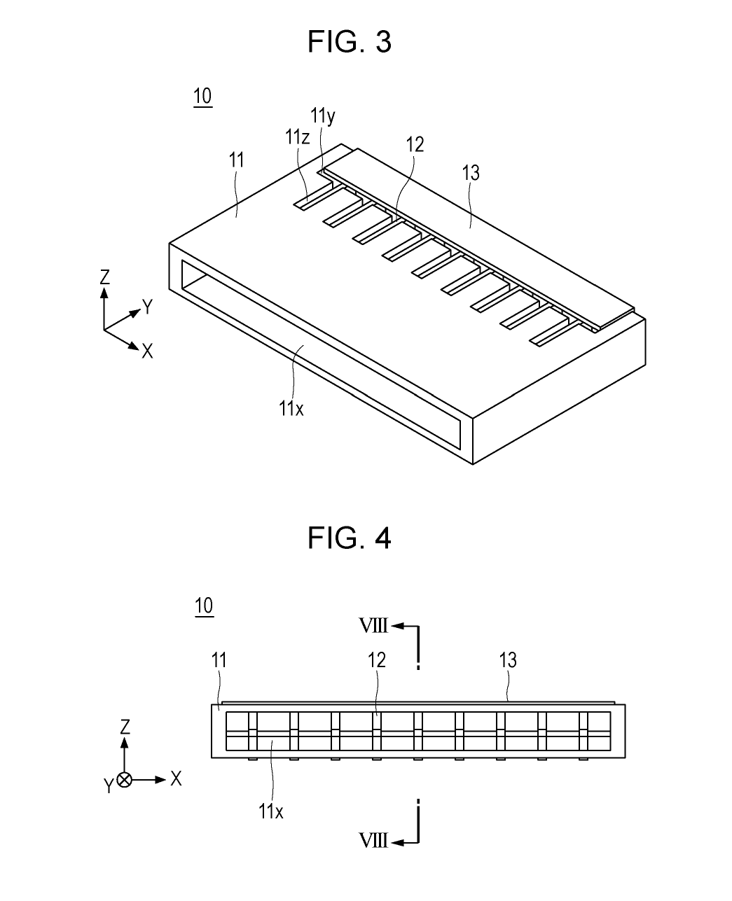

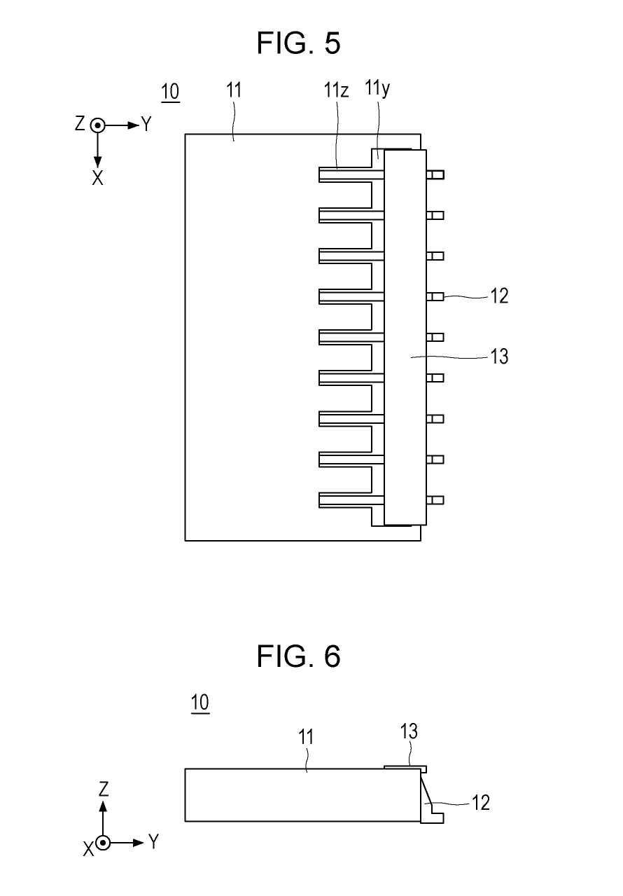

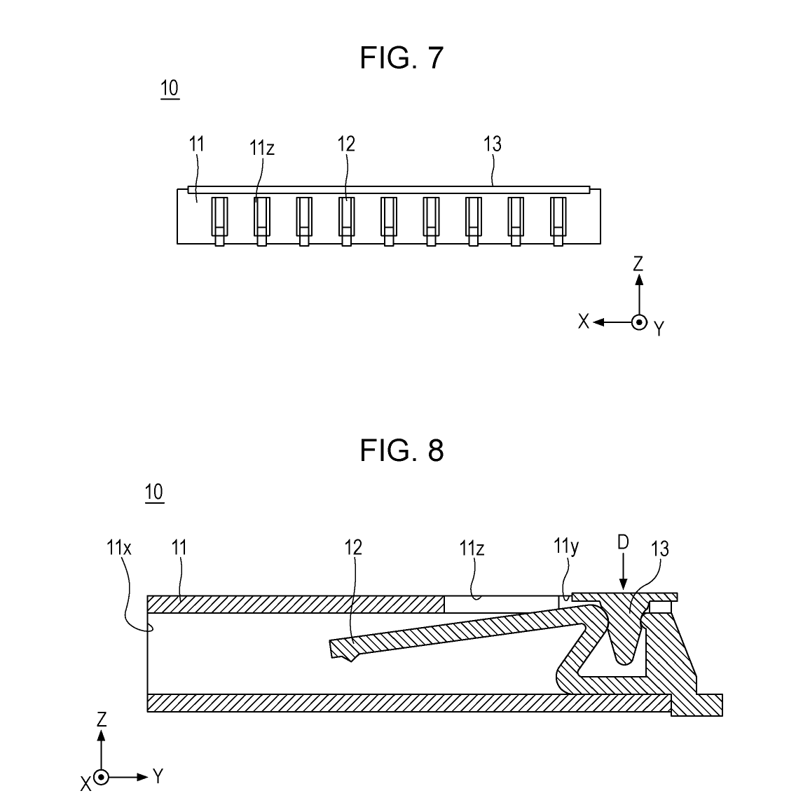

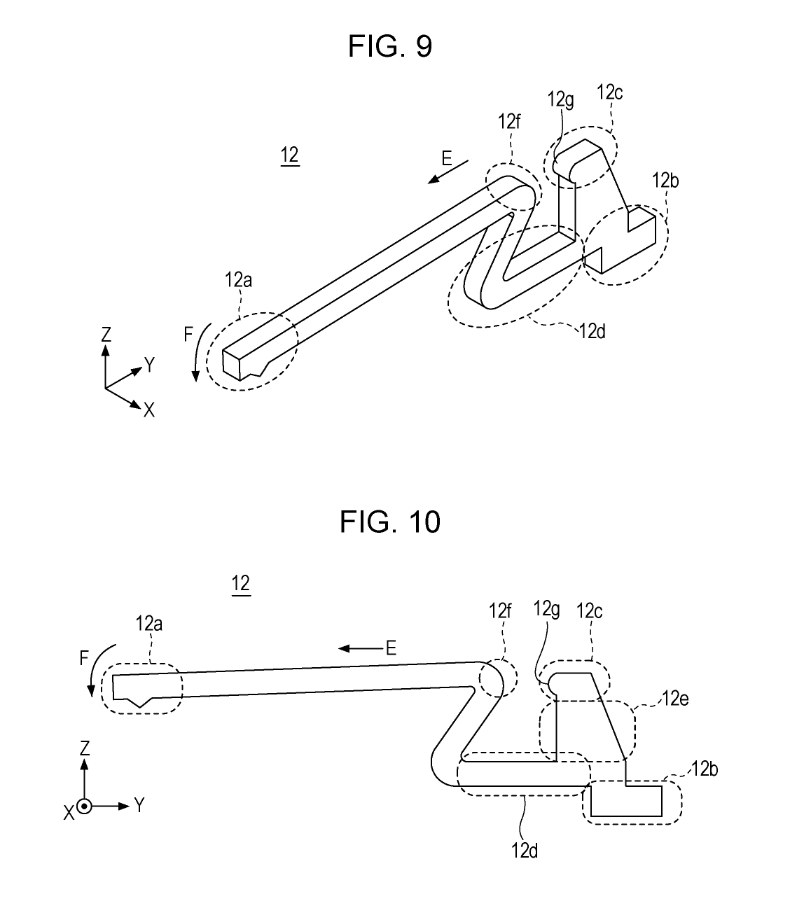

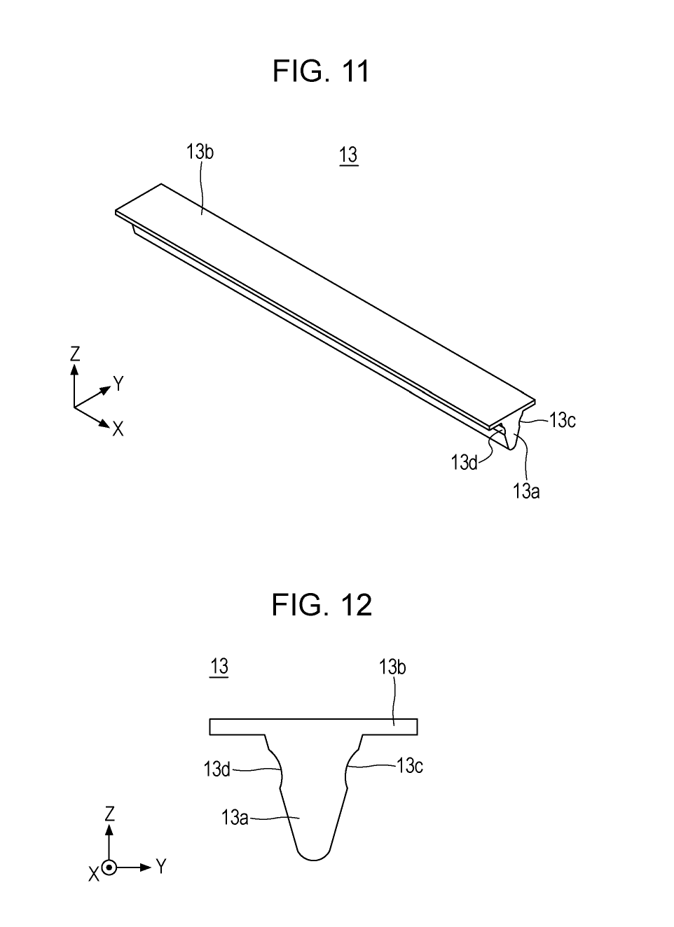

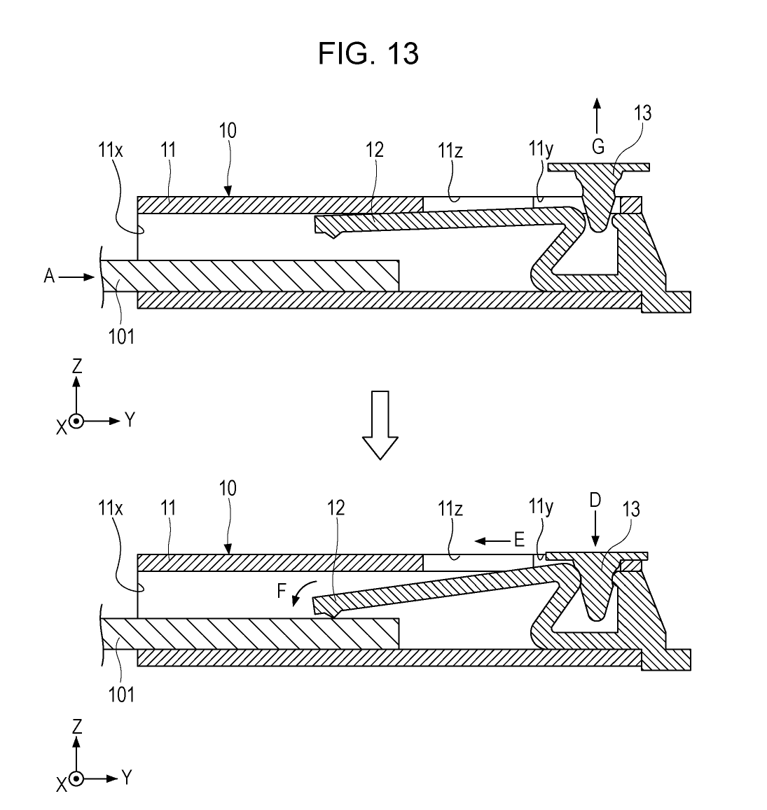

FIG. 3 is a perspective view illustrating a connector according to a first embodiment. FIG. 4 is a front view illustrating the connector according to the first embodiment. FIG. 5 is a plan view illustrating the connector according to the first embodiment. FIG. 6 is a right side view illustrating the connector according to the first embodiment. FIG. 7 is a rear view illustrating the connector according to the first embodiment. FIG. 8 is a cross-sectional view taken along line VIII-VIII in FIG. 4 illustrating the connector according to the first embodiment. FIG. 9 is a perspective view illustrating a contact according to the first embodiment. FIG. 10 is a right side view illustrating the contact according to the first embodiment. FIG. 11 is a perspective view illustrating an actuator according to the first embodiment. FIG. 12 is a right side view illustrating the actuator according to the first embodiment. FIG. 13 is a view for explaining an operation of the actuator according to the first embodiment.

Referring to FIGS. 3 to 8, a connector 10 is a ZIF, top contact, right angle connector including a housing 11, contacts 12, and an actuator 13. The connector 10 is a nine-pin connector having nine contacts 12 for example. However, the number of contacts 12 is not limited to nine, and may be desirably determined.

The housing 11 is molded with insulative resin and has, for example, a flat box-like shape. The housing 11 has a first insertion hole 11x and a second insertion hole 11y. For example, a flexible flat cable (FFC) or a flexible printed circuit (FPC) that serves as a connection subject having a conductive portion is inserted into the first insertion hole 11x. The actuator 13 is inserted into the second insertion hole 11y. The housing 11 also has nine third insertion holes 11z arranged side by side at a substantially regular pitch (for example, 0.3 mm pitch) in the X direction. The contacts 12 are inserted into the third insertion holes 11z. When the contacts 12 are inserted into (press-fitted into) the third insertion holes 11z from a rear surface side of the housing 11 (i.e., a side opposite to the first insertion hole 11x), the contacts 12 can be fixed to the housing 11. In the following description, a flexible printed circuit (FPC) is used for example; however, the description may be similar to that even if a flexible flat cable (FFC) or the like is used.

Referring to FIGS. 3 to 10, the contacts 12 are conductive terminals that become electrically continuous to the FPC when the FPC is inserted into the first insertion hole 11x. Each contact 12 is, for example, a metal plate having a width of about 0.2 mm. For example, the contact 12 may be formed by punching a thin metal plate containing phosphor bronze. The contact 12 mainly includes a contact portion 12a, a soldered portion 12b, a first press-fit portion 12c, a second press-fit portion 12d, a support portion 12e, and a pressure portion 12f. The contact 12 also has a protruding portion 12g so as to face the pressure portion 12f.

The contact portion 12a and the second press-fit portion 12d of the contact 12 are coupled to each other in a bending manner, or particularly in a substantially S-like form. Hence, the contact 12 has an easily bending form having a function of a spring. If the first press-fit portion 12c and the second press-fit portion 12d are fixed, the pressure portion 12f can be elastically displaced by a small operating force in a direction indicated by arrow E. When the pressure portion 12f is elastically displaced in the direction indicated by arrow E, the contact portion 12a is elastically displaced in a direction indicated by arrow F accordingly. The elastic displacement represents that the pressure portion 12f or the like is displaced only when an external force is applied to the pressure portion 12f, and the pressure portion 12f is restored to the original position when the external force is removed.

The contact portion 12a becomes electrically continuous to the FPC inserted into the first insertion hole 11x. The soldered portion 12b causes the contact 12 to be fixed to a substrate or the like with a solder and to be electrically connected with the substrate or the like. The FPC inserted into the first insertion hole 11x is electrically connected with the substrate or the like through the contact portion 12a and the soldered portion 12b. The first press-fit portion 12c and the second press-fit portion 12d fix the contact 12 to the housing 11. The support portion 12e receives a reactive force that is generated when the contact portion 12a is elastically displaced and the FPC inserted into the first insertion hole 11x is fitted to the contact 12. This will be described in detail below.

Referring to FIGS. 3 to 12, the actuator 13 includes a plate-like stopper portion 13b and a wedge-shaped insertion portion 13a protruding from one surface of the stopper portion 13b. The front surface of the insertion portion 13a (or a surface that contacts the pressure portion 12f of the contact 12) has a second recess 13d. Also, the rear surface of the insertion portion 13a (or a surface that contacts the protruding portion 12g of the contact 12) has a first recess 13c. The insertion portion 13a is inserted into a gap between the support portion 12e and the pressure portion 12f. When the actuator 13 is locked, the pressure portion 12f is elastically displaced relative to the support portion 12e. The material of the actuator 13 may be, for example, insulative resin. In the specification, the “wedge-shaped insertion portion” represents an insertion portion having a shape in which at least part of the width is gradually decreased from a position near to the stopper portion toward a position far from the stopper portion. Since the actuator 13 including the wedge-shaped portion is provided in the connector 10, the footprint of the connector 10 can be smaller than a case in which an actuator having a flip structure is provided.

The actuator 13 is movable in the Z direction in a state in which the insertion portion 13a is inserted into the second insertion hole 11y. When the actuator 13 is operated (moved) in a direction indicated by arrow D until the stopper portion 13b contacts the housing 11, the first recess 13c and the second recess 13d engage with and are fitted to the protruding portion 12g and the pressure portion 12f of the contact 12 due to the elasticity. Thus, the actuator 13 is locked. If the actuator 13 is locked in the state in which the FPC is inserted into the first insertion hole 11x, the FPC (the conductive portion of the connection subject) contacts the contact 12 with a predetermined pressure and the contact state is kept. Hereinafter, the state, in which the FPC contacts the contact 12 with the predetermined pressure and the contact state is kept, may be referred to as pressure contact state.

Since the lock structure is provided such that the first recess 13c and the second recess 13d of the actuator 13 are fitted to the protruding portion 12g and the pressure portion 12f of the contact 12, the feel of click occurs when the actuator 13 is locked. Accordingly, a fitted state (whether the actuator 13 is locked or not) can be recognized during the work. FIGS. 3 to 8 illustrate the state in which the actuator 13 is locked.

The operation of the actuator will be described in more detail below with reference to FIGS. 3 to 13. First, the actuator 13 is operated (moved) in a direction indicated by arrow G, so that the actuator 13 is unlocked. Then, a FPC 101 is inserted into the first insertion hole 11x of the housing 11 in a direction indicated by arrow A. In the state in which the actuator 13 is unlocked, the contact portion 12a of the contact 12 is located at a position at which the contact portion 12a does not contact the FPC 101 inserted into the first insertion hole 11x. In other words, in the state in which the actuator 13 is unlocked, the FPC 101 can be inserted into the first insertion hole 11x with zero insertion force.

Then, the actuator 13 is operated (moved) in the direction indicated by arrow D, the first recess 13c and the second recess 13d of the actuator 13 are fitted to the protruding portion 12g and the pressure portion 12f of the contact 12, and the actuator 13 is locked. At this time, the pressure portion 12f of the contact 12 is elastically displaced in the direction indicated by arrow E, and hence the contact portion 12a of the contact 12 is elastically displaced in the direction indicated by arrow F accordingly. Also at this time, a rotational force in the direction indicated by arrow F is exerted on the contact portion 12a of the contact 12. The contact force between the contact 12 and the FPC 101 is provided, and the FPC 101 and the contact 12 are brought into the pressure contact state.

A reactive force is generated when the contact portion 12a is elastically displaced and the FPC 101 and the contact 12 are brought into the pressure contact state. Thus, a portion that receives the generated reactive force is required. If the portion that receives the generated reactive force is not provided, the reactive force may be exerted on the soldered portion 12b, and if the soldered portion 12b is fixed to the substrate or the like with the solder, the solder may be separated from the substrate or the like. To avoid this, the support portion 12e is provided to receive the reactive force, which is generated when the FPC 101 and the contact 12 are brought into the pressure contact state, by the support portion 12e and to prevent the reactive force from being exerted on the soldered portion 12b.

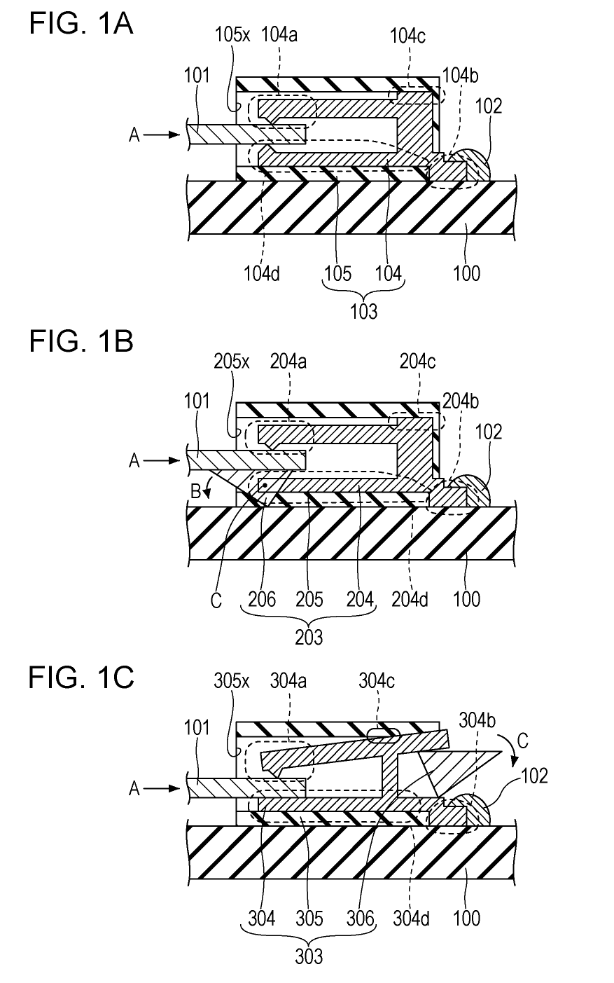

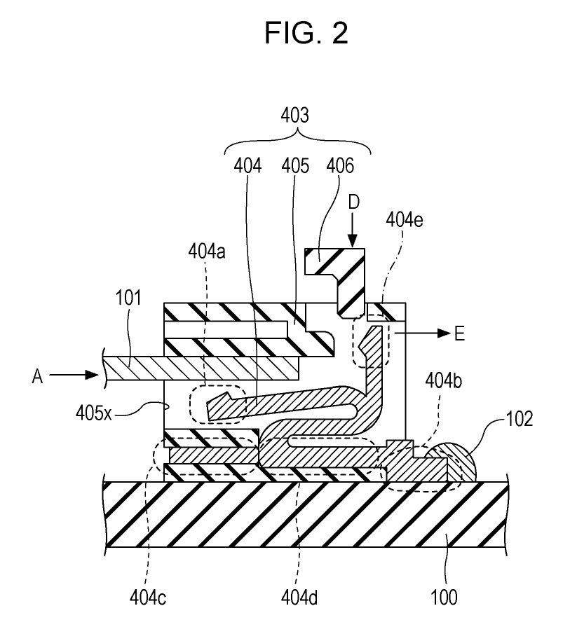

Regarding the conventional connector illustrated in any of FIGS. 1A to 1C and 2, the longitudinal direction of the support portion is substantially parallel to the longitudinal direction of the FPC inserted into the FPC insertion hole, and part of the support portion overlaps part of the FPC inserted into the FPC insertion hole in plan view. The structure of the support portion disturbs the reduction in thickness of the connector.

In contrast, regarding the connector 10, the support portion 12e is fixed to a rear portion of the connector 10 (at a position near to the rear surface of the housing 11) so that the longitudinal direction of the support portion 12e extends along the thickness direction (the Z direction) of the connector 10. That is, the support portion 12e is fixed at a position at which the support portion 12e does not overlap the FPC 101 inserted into the first insertion hole 11x of the housing 11 in plan view. Since the support portion 12e does not overlap the FPC 101 inserted into the first insertion hole 11x in plan view, the position of the contact portion 12a can be lowered with respect to the bottom surface of the housing 11 as compared with the position of the support portion of the conventional connector. Thus, the connector 10 can be reduced in thickness.

In the first embodiment, the support portion of the connector is arranged in the rear portion of the connector (at the position near to the rear surface of the housing 11). Also, the actuator that causes the rotational force to be exerted on the contact portion of the contact by the predetermined operation and provides the contact force between the contact and the FPC or the like is provided in the rear portion of the connector (at the position near to the rear surface of the housing 11). As the result, the support portion does not overlap the FPC or the like inserted into the connector in plan view. The position of the contact portion can be lowered with respect to the bottom surface of the housing as compared with the position of the support portion of the conventional connector. Thus, the connector can be reduced in thickness.

Since the connector according to the first embodiment is ZIF type, the FPC or the like can be inserted into the connector with zero insertion force. Thus, the workability is not degraded when the FPC or the like is inserted into the connector.

The smallest total thickness of the commercially available connector of ZIF, right angle type is about 0.65 mm. If the structure of the support portion described in the first embodiment is used, the thickness can be reduced by about 0.15 mm, and hence, the total thickness of the connector can be about 0.5 mm. With regard to current situation in which a product with such a connector mounted is progressively reduced in size and thickness, the reduction in total thickness by about 0.15 mm has significant technical meaning.

### First Modification of First Embodiment

In the first embodiment, the contact 12 includes the protruding portion 12g and the pressure portion 12f, whereas the actuator 13 has the first recess 13c and the second recess 13d. The first recess 13c and the second recess 13d of the actuator 13 are fitted to the protruding portion 12g and the pressure portion 12f of the contact 12. Thus, the actuator 13 is locked. A first modification of the first embodiment uses an actuator 23 having a first inclination 23c and a second inclination 23d, instead of the actuator 13.

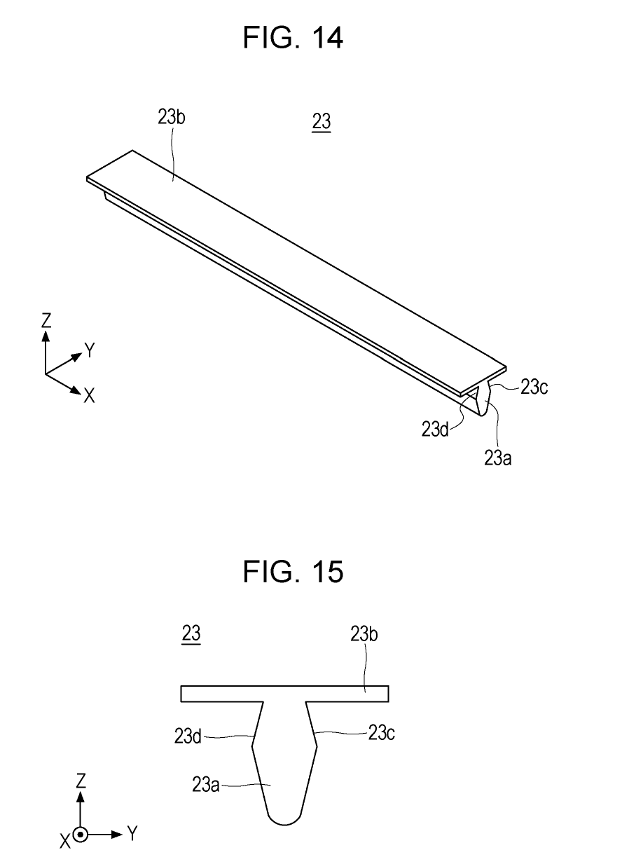

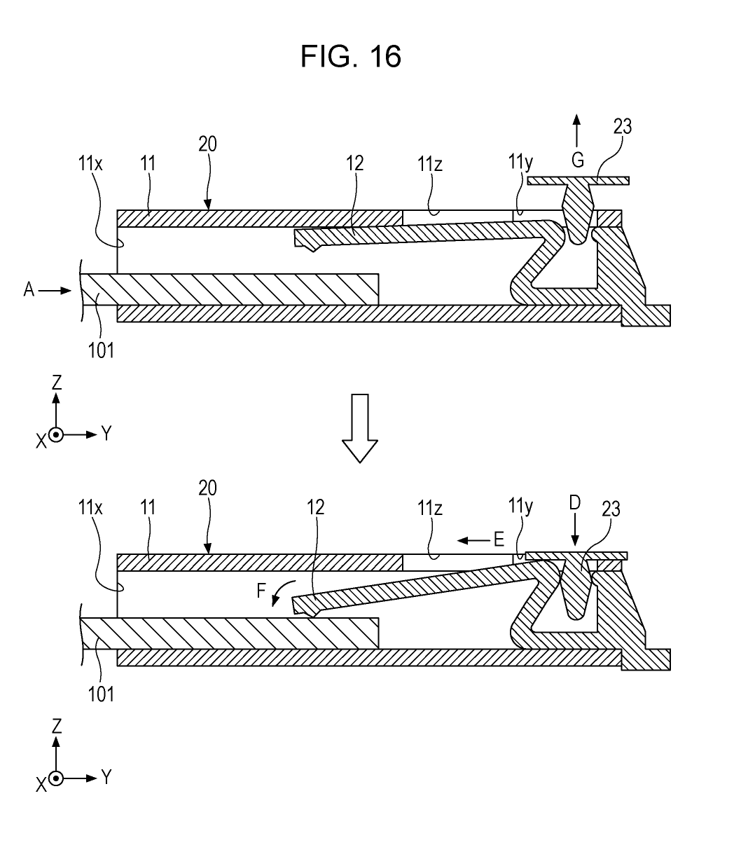

FIG. 14 is a perspective view illustrating the actuator according to the first modification of the first embodiment. FIG. 15 is a right side view illustrating the actuator according to the first modification of the first embodiment. FIG. 16 is a view for explaining an operation of the actuator according to the first modification of the first embodiment. Referring to FIGS. 14 to 16, a connector 20 according to the first modification of the first embodiment has a similar structure to the connector 10 except that the actuator 23 is provided instead of the actuator 13. The connector 20, in particular, portions different from those of the connector 10 will be mainly described below and description for portions equivalent to those of the connector 10 will be omitted.

The actuator 23 includes a plate-like stopper portion 23b and a wedge-shaped insertion portion 23a protruding from one surface of the stopper portion 23b. The front surface of the insertion portion 23a (or a surface that contacts the pressure portion 12f of the contact 12) has the second inclination 23d. Also, the rear surface of the insertion portion 23a (or a surface that contacts the protruding portion 12g of the contact 12) has the first inclination 23c. The insertion portion 23a is inserted into a gap between the support portion 12e and the pressure portion 12f. When the actuator 23 is locked, the pressure portion 12f is elastically displaced relative to the support portion 12e. The material of the actuator 23 may be, for example, insulative resin. The insertion portion 23a has a width that is increased from a position near to the stopper portion 23b toward a position far from the stopper portion 23b (in the Y direction) and then is gradually decreased further toward the position far from the stopper portion 23b (in the Y direction). Thus, the insertion portion 23a is the “wedge-shaped insertion portion.” Since the actuator 23 including the wedge-shaped portion is provided in the connector 20, the footprint of the connector 20 can be smaller than the case in which the actuator having the flip structure is provided.

The actuator 23 is movable in the Z direction in a state in which the insertion portion 23a is inserted into the second insertion hole 11y. When the actuator 23 is operated (moved) in a direction indicated by arrow D until the stopper portion 23b contacts the housing 11, a recess that is defined by the first inclination 23c and the lower surface of the stopper portion 23b, and a recess that is defined by the second inclination 23d and the lower surface of the stopper portion 23b engage with and are fitted to the protruding portion 12g and the pressure portion 12f of the contact 12 due to the elasticity. Thus, the actuator 23 is locked. If the actuator 23 is locked in the state in which the FPC is inserted into the first insertion hole 11x, the FPC contacts the contact 12 with a predetermined pressure and the contact state is kept.

Since the lock structure is provided such that the recesses defined by the lower surface of the stopper portion 23b, and the first inclination 23c and the second inclination 23d of the actuator 23 are fitted to the protruding portion 12g and the pressure portion 12f of the contact 12, the feel of click occurs when the actuator 23 is locked. Accordingly, a fitted state (whether the actuator 23 is locked or not) can be recognized during the work.

Next, the operation of the actuator 23 will be described in more detail below. First, the actuator 23 is operated (moved) in a direction indicated by arrow G, so that the actuator 23 is unlocked. Then, a FPC 101 is inserted into the first insertion hole 11x of the housing 11 in a direction indicated by arrow A. In the state in which the actuator 23 is unlocked, the contact portion 12a of the contact 12 is located at a position at which the contact portion 12a does not contact the FPC 101 inserted into the first insertion hole 11x. In other words, in the state in which the actuator 23 is unlocked, the FPC 101 can be inserted into the first insertion hole 11x with zero insertion force.

Then, the actuator 23 is operated (moved) in the direction indicated by arrow D, the first inclination 23c and the second inclination 23d of the actuator 23 are fitted to the recesses defined by the lower surface of the stopper portion 23b, and the protruding portion 12g and the pressure portion 12f of the contact 12, and the actuator 23 is locked. At this time, the pressure portion 12f of the contact 12 is elastically displaced in a direction indicated by arrow E, and hence the contact portion 12a of the contact 12 is elastically displaced in a direction indicated by arrow F accordingly. Also at this time, a rotational force in the direction indicated by arrow F is exerted on the contact portion 12a of the contact 12. The contact force between the contact 12 and the FPC 101 is provided, and the FPC 101 and the contact 12 are brought into the pressure contact state.

As described above, the connector according to the first modification of the first embodiment that uses the actuator having the first and second inclinations can attain an advantage similar to that of the first embodiment.

### Second Modification of First Embodiment

A second modification of the first embodiment uses an actuator having a shape that is different from those of the first embodiment and the first modification of the first embodiment. The actuator according to the second modification of the first embodiment includes, in addition to the lock mechanism, an extraction prevention portion that prevents the actuator from being extracted from the housing.

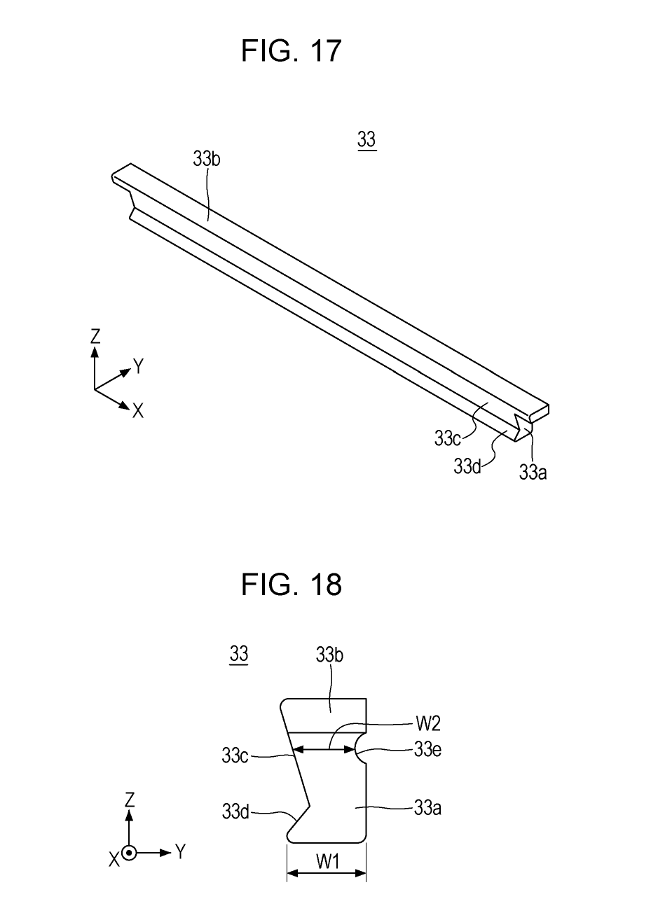

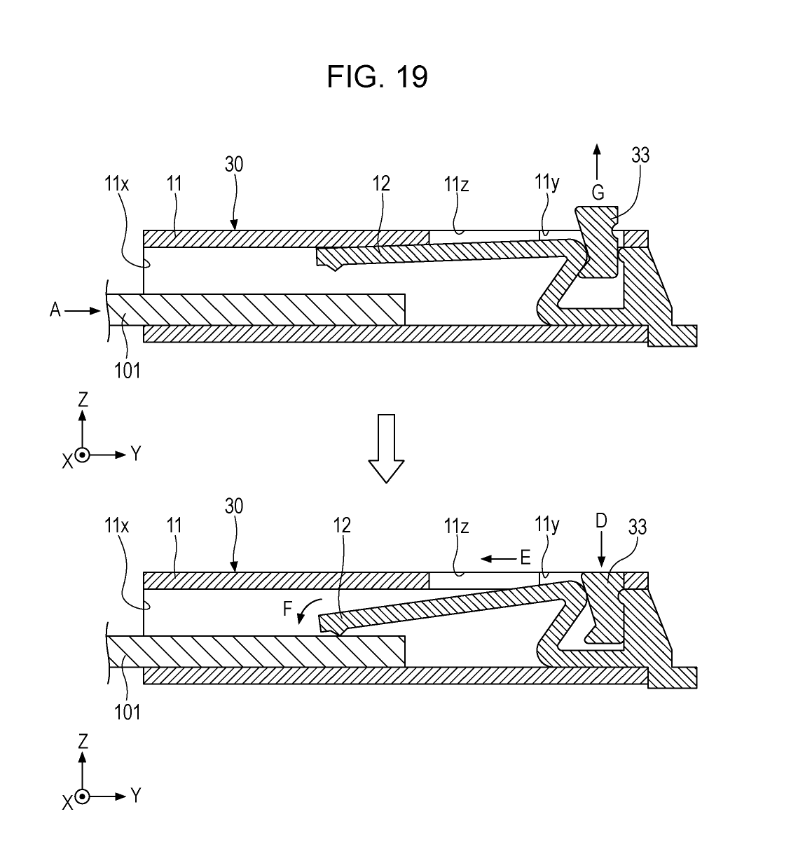

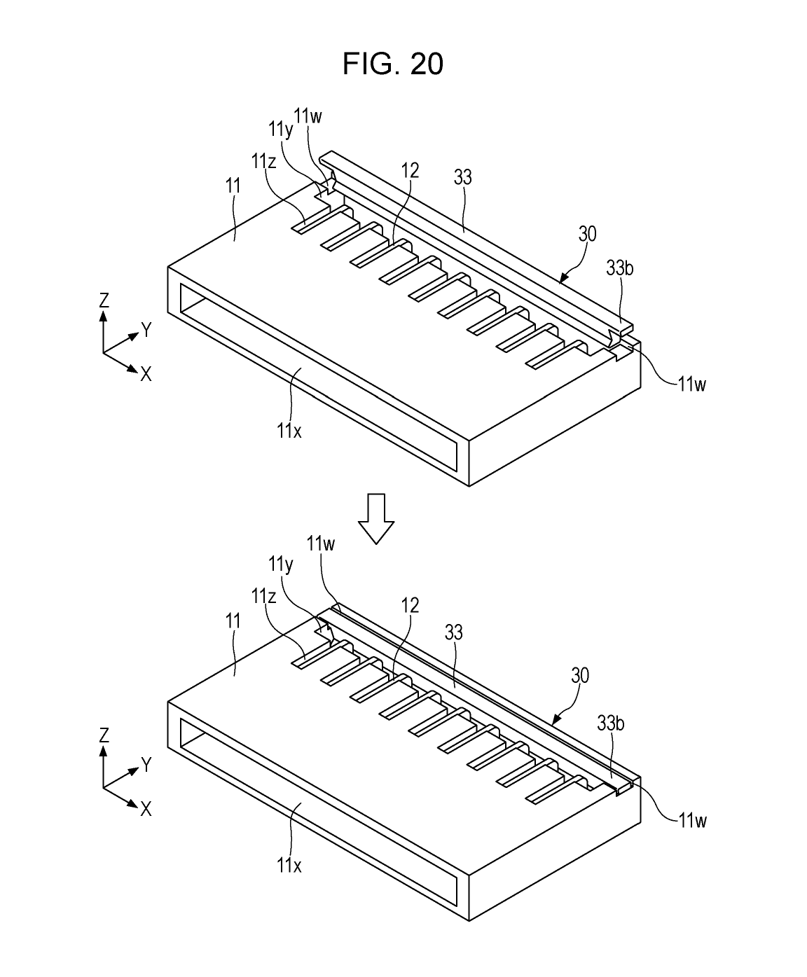

FIG. 17 is a perspective view illustrating the actuator according to the second modification of the first embodiment. FIG. 18 is a right side view illustrating the actuator according to the second modification of the first embodiment. FIGS. 19 and 20 are views for explaining an operation of the actuator according to the second modification of the first embodiment. Referring to FIGS. 17 to 20, a connector 30 according to the second modification of the first embodiment has a similar structure to the connector 10 except that an actuator 33 is provided instead of the actuator 13 and a housing 11 has grooves 11w. The connector 30, in particular, portions different from those of the connector 10 will be mainly described below and description for portions equivalent to those of the connector 10 will be omitted.

The actuator 33 includes a plate-like stopper portion 33b and a wedge-shaped insertion portion 33a protruding from one surface of the stopper portion 33b. The insertion portion 33a is inserted into a gap between the support portion 12e and the pressure portion 12f. When the actuator 33 is locked, the pressure portion 12f is elastically displaced relative to the support portion 12e. The material of the actuator 33 may be, for example, insulative resin. The insertion portion 33a has a shape in which part of the width is gradually decreased from a position near to the stopper portion 33b toward a position far from the stopper portion 33b (in the Y direction). Thus, the insertion portion 33a is the “wedge-shaped insertion portion.” Since the actuator 33 including the wedge-shaped portion is provided in the connector 30, the footprint of the connector 30 can be smaller than the case in which the actuator having the flip structure is provided.

The front surface of the insertion portion 33a (or a surface that contacts the pressure portion 12f of the contact 12) has a first inclination 33c and a second inclination 33d. The first inclination 33c is arranged such that the width of the insertion portion 33a is gradually decreased from one end (near to the stopper portion 33b) toward the other end (near to the press-fit portion 12d). The second inclination 33d is arranged such that the width of the insertion portion 33a is gradually increased from a portion with the smallest width (in the Y direction) toward the other end (near to the press-fit portion 12d). The rear surface of the insertion portion 33a (or a surface that contacts the protruding portion 12g of the contact 12) is a vertical surface extending substantially in the Z direction, and has a recess 33e.

Both ends of the stopper portion 33b in the longitudinal direction (the X direction) of the actuator 33 protrude in the X direction as compared with the insertion portion 33a (hereinafter, the protruding portions are referred to as protruding portions of the stopper portion 33b). The protruding portions of the stopper portion 33b are fit to the grooves 11w of the housing 11 when the actuator 33 is locked. The structure in which the protruding portions of the stopper portion 33b are fitted to the grooves 11w is provided to prevent the actuator 33 from being excessively deeply inserted into the housing 11 when the actuator 33 is pushed into the housing 11. Also, by manually holding the protruding portions of the stopper portion 33b and lifting up the protruding portions, the actuator 33 can be unlocked.

The actuator 33 is movable in the Z direction in a state in which the insertion portion 33a is inserted into the second insertion hole 11y. When the actuator 33 is operated (moved) in a direction indicated by arrow D until the protruding portions of the stopper portion 33b contact the grooves 11w of the housing 11, the first inclination 33c contacts the pressure portion 12f of the contact 12, and causes the pressure portion 12f to be elastically displaced in a direction indicated by arrow E. At this time, the recess 33e engages with and is fitted to the protruding portion 12g of the contact 12 due to the elasticity. Thus, the actuator 33 is locked. If the actuator 33 is locked in the state in which the FPC is inserted into the first insertion hole 11x, the FPC contacts the contact 12 with a predetermined pressure and the contact state is kept. At this time, the rear surface of the actuator 33 is closely in contact with the support portion 12e. Hence, the FPC and the contact 12 are stably held with a predetermined contact pressure.

Since the lock structure is provided such that the recess 33e of the actuator 33 is fitted to the protruding portion 12g of the contact 12, the feel of click occurs when the actuator 33 is locked. Accordingly, a fitted state (whether the actuator 33 is locked or not) can be recognized during the work.

Next, the operation of the actuator 33 will be described in more detail below. First, the actuator 33 is operated (moved) in a direction indicated by arrow G, so that the actuator 33 is unlocked. At this time, a width W1 at the bottom portion of the actuator 33 is larger than a smallest distance W2 between the protruding portion 12g and the pressure portion 12f of the contact 12, and hence the actuator 33 can be prevented from being extracted from the housing 11. That is, the bottom portion of the actuator 33 functions as the extraction prevention portion.

Then, a FPC 101 is inserted into the first insertion hole 11x of the housing 11 in a direction indicated by arrow A. In the state in which the actuator 33 is unlocked, the contact portion 12a of the contact 12 is located at a position at which the contact portion 12a does not contact the FPC 101 inserted into the first insertion hole 11x. In other words, in the state in which the actuator 33 is unlocked, the FPC 101 can be inserted into the first insertion hole 11x with zero insertion force.

Then, the actuator 33 is operated (moved) in the direction indicated by arrow D, the recess 33e of the actuator 33 is fitted to the protruding portion 12g of the contact 12, and the actuator 33 is locked. At this time, the first inclination 33c contacts the pressure portion 12f of the contact 12, and the pressure portion 12f is elastically displaced in the direction indicated by arrow E. Hence, the contact portion 12a of the contact 12 is elastically displaced in a direction indicated by arrow F accordingly. Also at this time, a rotational force in the direction indicated by arrow F is exerted on the contact portion 12a of the contact 12. The contact force between the contact 12 and the FPC 101 is provided, and the FPC 101 and the contact 12 are brought into the pressure contact state.

As described above, the connector according to the second modification of the first embodiment that uses the actuator having the first and second inclinations and the recess can attain an advantage similar to that of the first embodiment. In addition, the following advantage is attained. Since the extraction prevention portion is provided such that the width of the bottom portion of the actuator is larger than the smallest distance between the protruding portion and the pressure portion of the contact, the actuator can be prevented from being extracted from the housing when the actuator is unlocked.

### Third Modification of First Embodiment

A third modification of the first embodiment uses an actuator that is made of a flexible material.

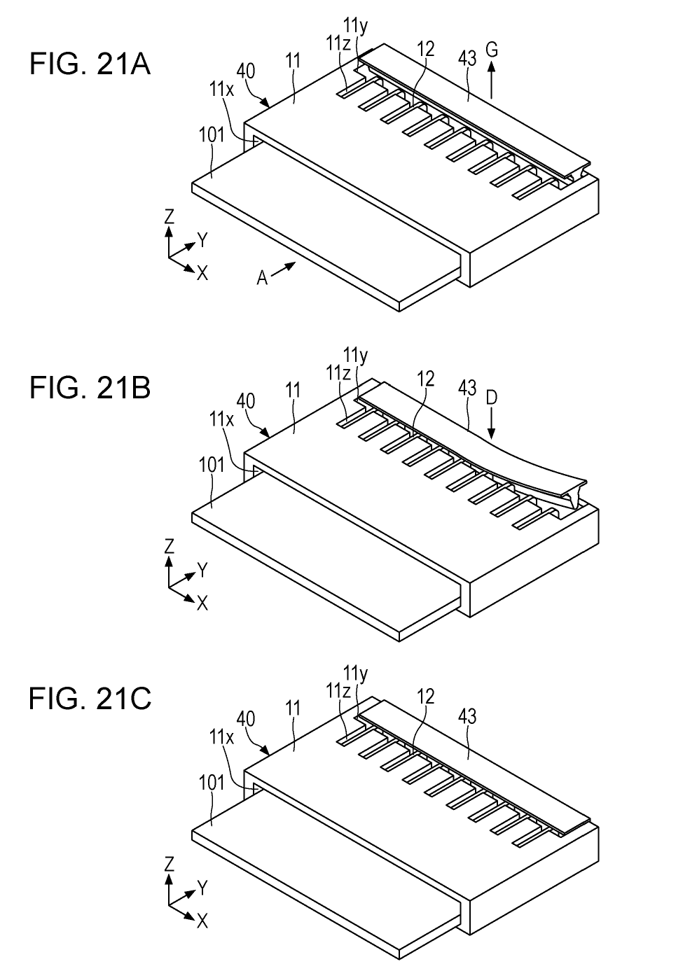

FIGS. 21A to 21C are views for explaining an operation of the actuator according to the third modification of the first embodiment. Referring to FIGS. 21A to 21C, a connector 40 according to the third modification of the first embodiment has a similar structure to the connector 10 except that an actuator 43 is provided instead of the actuator 13. The connector 40, in particular, portions different from those of the connector 10 will be mainly described below and description for portions equivalent to those of the connector 10 will be omitted.

In the connector 40, the structure of the actuator 43 is similar to that of the actuator 13 according to the first embodiment except that the actuator 43 is made of a material with a certain flexibility, and hence is flexible in a direction in which the contacts 12 are arranged side by side. The actuator 43 is put into a reflow furnace, as a component of the connector 40. Thus, the actuator 43 uses a material with a certain heat resistance that is not deformed at a reflow temperature (for example, 245 degrees centigrade). A reactive force generated at the contact is exerted on the support portion and the actuator 43. Thus, the actuator 43 uses a material with a certain strength that is not permanently deformed by the reactive force. The material of the actuator 43 may be desirably selected from materials having the certain flexibility, heat resistance, and strength. For example, the material may be nylon.

Next, the operation of the actuator 43 will be described. First, referring to FIG. 21A, the actuator 43 is operated (moved) in a direction indicated by arrow G, the actuator 43 is unlocked, and a FPC 101 is inserted into the first insertion hole 11x of the housing 11 in a direction indicated by arrow A. In the state in which the actuator 43 is unlocked, the contact portion 12a of the contact 12 is located at a position at which the contact portion 12a does not contact the FPC 101 inserted into the first insertion hole 11x. In other words, in the state in which the actuator 43 is unlocked, the FPC 101 can be inserted into the first insertion hole 11x with zero insertion force.

Then, referring to FIG. 21B, one end of the actuator 43 in the longitudinal direction is operated (moved) in a direction indicated by arrow D. Since the actuator 43 is made of the flexible material such as nylon, the actuator 43 is bent like an arc, and only the one end of the actuator 43 in the longitudinal direction is locked. Further, the actuator 43 is gradually operated (moved) in the direction indicated by arrow D from the one end toward the other end of the actuator 43 in the longitudinal direction. As the result, the actuator 43 is gradually locked from the one end toward the other end of the actuator 43 in the longitudinal direction like a zipper being zipped. Finally, the actuator 43 is completely locked as illustrated in FIG. 21C.

As described above, the connector according to the third modification of the first embodiment that uses the actuator made of the flexible material can attain an advantage similar to that of the first embodiment. In addition, the following advantage is attained. Since the actuator made of the flexible material is used, the actuator can be gradually locked from an end. Thus, the actuator can be locked by a small operating force, and the workability can be increased.

Recently, a multi-contact connector with more than 100 contacts is used. The actuator made of the flexible material can be effectively used particularly for the multi-contact connector. If the number of contacts is increased (in the case of the multi-contact connector), the actuator may be divided into a plurality of pieces.

The preferred embodiment has been described above; however, the embodiment is not limited and may be modified and changed in various forms within the scope described in the claims.

For example, the actuator 23 or 33 may be made of a flexible material like the material of the actuator 43.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A connector to be mounted on a substrate, the connector comprising:
a housing member having an opening portion in which an electrical device is to be inserted; and
a contact member provided in the housing member to electrically connect the electrical device with the substrate, the contact member including:
a first portion,
a second portion facing the first portion with a gap and supported elastically with respect to the first portion, and
a third portion supported by the second portion, wherein the third portion comes into contact with a terminal of the electrical device electrically when the second portion is pushed by a pushing member which is to be inserted into the gap between the first portion and the second portion.

2. The connector according to claim 1, wherein the second portion is pushed by the pushing member at a pushing force same to a reactive force at which the first portion is pushed by the pushing member when the second portion is pushed.

3. The connector according to claim 1, wherein the first portion is fixed to the housing member.

4. The connector according to claim 1, wherein the first portion is disposed on a side opposite to the third portion with respect to the second portion.

5. A connector to be mounted on a substrate, the connector comprising:
a housing member having an opening portion in which an electrical device is to be inserted;
a contact member provided in the housing member to electrically connect the electrical device with the substrate, the contact member including:
a first portion,
a second portion facing the first portion with a gap and supported elastically with respect to the first portion, and
a third portion supported by the second portion; and
a pushing member to push the second portion so that the third portion comes into contact with a terminal of the electrical device electrically, upon being inserted into the gap between the first portion and the second portion.

6. The connector according to claim 5, wherein each of the contact members further includes:
a fourth portion connecting the first portion and the second portion, the fourth portion extending on a side of the gap between the first portion and the second portion to define a space communicating with the gap, and
the pushing member includes:
an engaging portion to be inserted into the space, and
a stopping portion to be disposed outside of the space to stop the engaging portion from advancing over a given deepness in the space.

7. The connector according to claim 6, wherein the fourth portion defines the space larger than the gap in a direction parallel to the gap.

8. The connector according to claim 7, wherein the pushing member further includes:
a preventing portion provided on the engaging portion to prevent the engaging portion from coming out of the space, the preventing portion being larger than the gap in the direction parallel to the gap.

9. The connector according to claim 5, wherein a plurality of the contact members are arranged along a line defined in the housing member, and
the pushing member extends along the line to push a plurality of the second portions of the contact members.

10. The connector according to claim 9, wherein the pushing member is flexible so as to be attached or removed with respect to each contact member one by one.
